(19) United States
(12) Patent Application Publication
(10) Pub. No.: US 2014/0375819 A1
(43) Pub. Date: Dec. 25, 2014

(54) AUTONOMOUS VIDEO MANAGEMENT SYSTEM

(71) Applicant: Pivotal Vision, LLC, Bloomington, MN (US)

(72) Inventors: Colin Larsen, Minneapolis, MN (US); Ed Koezly, Ham Lake, MN (US)

(21) Appl. No.: 14/313,653

(22) Filed: Jun. 24, 2014

Related U.S. Application Data
(60) Provisional application No. 61/838,636, filed on Jun. 24, 2013.

(51) Int. Cl. H04N 7/18

(52) U.S. Cl. CPC H04N 7/181
USPC 348/159

(57) ABSTRACT

An autonomous video management system. The system includes one or more remote sites, each of the one or more remote sites including an intelligent video appliance operably coupled to one or more cameras, a system management controller configured to provide an operable connection to one or more user interface workstations for monitoring events at the one or more remote sites, wherein the events are triggered by activity detected by the one or more cameras. Other embodiments include the intelligent video appliance is further coupled to one or more sensors, wherein the events are triggered by activity detected by the one or more sensors.

### RELATED APPLICATION

The present application claims the benefit of U.S. Provisional Application No. 61/838,636 filed Jun. 24, 2013, which is incorporated herein in its entirety by reference.

### FIELD OF THE INVENTION

The invention relates generally to remote monitoring and security systems. More specifically, the invention relates to autonomous video monitoring systems and methods.

### BACKGROUND OF THE INVENTION

Standard closed-circuit television (CCTV) systems have long been used to monitor locations requiring security. Such CCTV systems remotely monitor buildings, military installations, infrastructure, industrial processes, and other sensitive locations. As real and perceived threats against persons and property grow, the list of locations requiring remote security monitoring also grows. For example, regularly unmanned infrastructure such as power substations, oil rigs, bridges, and so on, may now require protection through remote monitoring.

These traditional video surveillance systems may include networked video detectors, sensors, and other equipment connected to a central site. One of the drawbacks to such traditional monitoring systems is that they often rely on human supervision to view video images, interpret the images, and determine a relevant course of action such as alerting authorities. The high cost of manning such systems makes them impractical when a large number of remote sites require monitoring. Additionally, for operations that have many sites or individual sites that are large, humans are limited by how much information they can continuously pay attention to or simultaneously analyze. Furthermore, a lack of automation in analysis and decision process increases response time and decreases reliability.

Known automated monitoring systems solve many of these problems. Such known automated systems digitally capture and stream video images, detect motion, and provide automatic alerts based on parameters such as motion, sound, heat and other parameters. However, these known automated systems often do not coordinate video across multiple cameras or coordinate among the same event.

Therefore, there is a need for reliable systems and methods of autonomous video management for the coordination of multiple video views with respect to triggered events for purposes of assessment of situations and tactical decision-making

### SUMMARY OF THE INVENTION

Embodiments of an autonomous video management system comprise an IP-based video and device management platform. Embodiments include geo-terrestrial-based sensor analytics. Because the system combines video, device management and advanced sensor analytics, the system is configured to perform real-time situational analysis, which allows users to spend more time determining that the next steps should be rather than determining what is happening. The gaining of real-time situational awareness makes users of the system more efficient and proactive when managing multiple cameras and sites.

According to an embodiment, the system utilizes real-time edge autonomous and smart monitoring technology, sends live and captured video only upon the occurrence of an incident. This exception-based technology creates an advanced network environment capable of handling large volumes of video and device triggers which allows these devices to immediately generate and send event information, associated alarm information and real-time video to the systems users.

Embodiments are specifically designed for high-risk, high-profile security environments. In an embodiment, the system can be configured for a single standalone site with hundreds of cameras or as independent sites with hundreds of cameras, for example. Greater or fewer cameras are also possible. The proven scalability and usability of the federated architecture makes the amount of cameras, sensors, sites and users limitless.

In a feature and advantage of embodiments of the invention, multiple sensor trips can be managed. Further, video can be displayed prior to the event trip. For example, 10 seconds of video pre-event and 15 seconds of video post-event from two sets of four-to-multiple camera views per sensor, can be simultaneously displayed, as well as incorporating current live video for each camera and recorded video. In embodiments, different periods of time pre-event and post-event can be sampled and displayed. In embodiments, the periods of time pre-event and post-event can be variable and user-defined. In embodiments, the number of camera views per sensor can be variable, including less than or greater than four per sensor.

In embodiments, one live video and one recorded video are displayed for a particular event. In other embodiments, a group of four camera views is treated as a single event. As a result, all four camera views are displayed at the same time for a particular event. In other embodiments, additional or fewer camera views can be treated as a single event. Once the event is assessed, a user can select a cause code and acknowledge the views together.

In operation, according to an embodiment, when visual motion has been validated on a camera or an I/O input device connected to a sensor is triggered, the system creates an event and assigns an event ID to all of the cameras associated with that event. That event ID is used to post alarm messages and information to the remote console, which is the display viewer of all system output. System information is displayed in the form of live video windows, recorded video, panoramic views, and sky views with object motion plotted in real time. In embodiments, all the views are synched with geo-terrestrial analytics.

For tactical decision-makers, knowing what has happened, how many simultaneous activities are underway in the field, and how big of a threat is underway is essential to tactical decision-making. Therefore, having the activities analyzed, packaged, and presented in a logical order and with multiple perspectives is very valuable. Embodiments of the present invention provide maximum situational awareness for these circumstances. When out-of-the-ordinary activities that may be a threat are underway, embodiments of the system notifies users that an event has occurred. The system is configured to collect pertinent information and assemble it without human interaction and classify it under an event and place it in a queue. Such information can include a video or data for a period of time leading up to the event, video or data for the first few seconds of the event, and video or data for post-event. In an embodiment, then, event information and pre-event and post-event recorded video is available for assessment.

When the user selects an event in the situational playback event queue, a period of video from each camera associated with that selected event ID populates the first available group with video prior to and after initiation of the event. All of the video clips automatically start playing synchronously in the situational playback video players along with a display of live camera views. Of course, differing lengths of video clips can be populated. In embodiments, the period of video is variable and user-defined. As a result, the user can immediately assess and identify what created the event, apply a reason code and acknowledge the event. Once a user acknowledges the event, all of the situational playback video players along with the live action video windows, event information clears and is ready for the next event in the situational playback event queue to be selected and assessed.

In embodiments, the system comprises a virtual matrix switch that uses an IP network to route compressed digital video streams. The source of the video can be signals from an IP camera or analog camera, in embodiments. The video is carried over IP using standard network protocols. In embodiments then, each camera and other operably coupled piece of hardware includes its own IP address. The network framework is therefore readily scalable due to the IP connectivity.

According to embodiments, the features and embodiments described herein can be utilized in combination with features and elements of motion-validating remote monitoring systems, including geospatial mapping; for example, that described in U.S. Patent Publication No. 2009/0010493, which is incorporated herein by reference in its entirety.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a block diagram of an autonomous video management system architecture, according to an embodiment of the invention.

FIG. 2 is a work station interface to an autonomous video management system, according to an embodiment of the invention.

FIG. 3 is screenshots of output of an adaptive video analytics engine, according to an embodiment of the invention.

FIG. 4 is a screenshot of output of a geospatial display module, according to an embodiment of the invention.

FIG. 5 is a screenshot of output of a single situational playback window, according to an embodiment of the invention.

FIG. 6 is a screenshot of camera displays, according to an embodiment of the invention.

FIG. 7 is a screenshot of an activity report window and event acknowledgement window, according to an embodiment of the invention.

FIG. 8 is a screenshot of a system camera selector window and a sensor monitor window, according to an embodiment of the invention.

FIG. 9 is screenshots of output of a system status module, according to an embodiment of the invention.

FIG. 10 is a flow diagram of operation of the event categorization of the system, according to an embodiment of the invention.

FIG. 11 is a screenshot of an event queue with live and recorded video groupings, according to an embodiment of the invention.

FIG. 12A is a visual motion analytics alarm event descriptor, according to an embodiment of the invention.

FIG. 12B is an I/O alarm event descriptor, according to an embodiment of the invention.

FIG. 13A is a screenshot of a situational playback group according to a distinct color and group name, according to an embodiment of the invention.

FIG. 13B is a screenshot of a situational playback group according to a distinct color and group name, according to an embodiment of the invention.

FIG. 14A is a screenshot of an event queue in a horizontal configuration, according to an embodiment of the invention.

FIG. 14B is a screenshot of an event queue in a vertical configuration, according to an embodiment of the invention.

FIG. 15A is a screenshot of a situational playback video player having controls visible, according to an embodiment of the invention.

FIG. 15B is a screenshot of a situational playback video player having controls hidden, according to an embodiment of the invention.

FIG. 16 is a screenshot of a live action video feed, according to an embodiment of the invention.

FIG. 17 is a screenshot of a control panel interface, according to an embodiment of the invention.

FIG. 18 is a screenshot of a situational playback group acknowledgement interface portion of a control panel interface, according to an embodiment of the invention.

FIG. 19A is a screenshot of an event manager interface portion of a control panel interface, according to an embodiment of the invention.

FIG. 19B is a screenshot of an event manager interface portion of a control panel interface, according to an embodiment of the invention.

FIG. 20 is a screenshot of a situational playback group playback control interface portion of a control panel interface, according to an embodiment of the invention.

FIG. 21 is a screenshot of a control panel interface with selected events and associated video feeds, according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

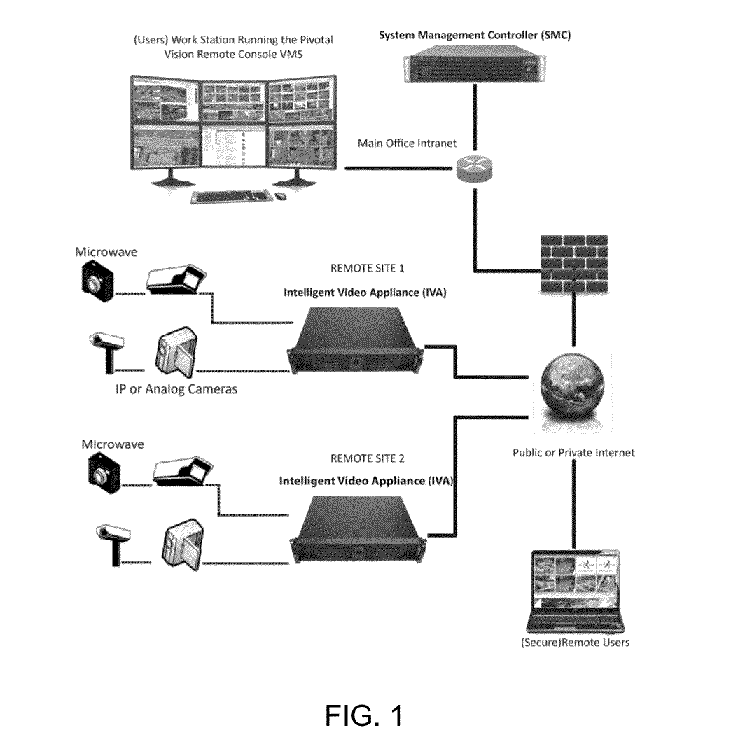

Referring to FIG. 1, embodiments of an autonomous video management system can comprise a work station interface, a system management controller (SMC), and one or more remote sites, the remote sites including an intelligent video appliance (IVA) operably coupled to one or more IP or analog cameras. In embodiments, one or more sensors, such as a microwave sensor, can be operably coupled to the IVA.

The SMC generally includes a processor and memory. The processor can be any programmable device that accepts digital data as input, is configured to process the input according to instructions or algorithms, and provides results as outputs. In an embodiment, the processor can be a central processing unit (CPU) configured to carry out the instructions of a computer program. The processor can therefore be configured to perform basic arithmetical, logical, and input/output operations.

Memory can comprise volatile or non-volatile memory as required by the coupled processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the IVA can monitor individual zones for examination. In an embodiment, one or more remote users can be connected to the system via a public or private internet. In embodiments, a firewall can be configured between the remote sites and the main office and SMC. In embodiments, the work station interface and SMC are coupled by an intranet or other suitable network. In embodiments, a sensor manager (not illustrated) can be coupled to the IVA and be configured to manage the individual cameras or sensors and subsequently report to the IVA the status of the cameras or sensors, if appropriate.

Referring again to FIG. 1, according to an embodiment of the system, the system provides a scalable architecture. Embodiments of the architecture therefore offer solutions for both large and small installations. The system provides operations having flexibility and unlimited expansion for more efficient management and deployment of surveillance assets over a large site or multiple sites due to the unlimited number of sites that can be added. In embodiments, administrators have the ability to centrally manage all sites as a single enterprise system within the system. Administrators can assign user rights for each individual site. In embodiments, users have access to cameras, devices, video and event-based reporting across all the individual sites in the system architecture.

In embodiments, centralized system administration management is provided. In a feature and advantage of embodiments of the invention, remote site setup and camera calibration can therefore be conducted. In another feature and advantage of embodiments of the invention, unlimited system and site expansion can therefore be offered. In another feature and advantage of embodiments of the invention, a single user interface for the entire system provides users a comprehensive system perspective. In another feature and advantage of embodiments of the invention, the system brings together geographically dispersed sites, thereby creating a single point of access to a global network of sites, cameras, and sensors. In another feature and advantage of embodiments of the invention, a virtual matrix and matrix switcher offers instant access to all system cameras. In another feature and advantage of embodiments of the invention, the system provides system-wide bandwidth management. According to embodiments, cameras can be streamed based on priority and bandwidth availability. In another feature and advantage of embodiments of the invention, the system provides system-wide health monitoring. In embodiments, real-time visibility of device, sensor, camera, and other components status can be easily and readily viewed by the user. In another feature and advantage of embodiments of the invention, the system provides streams to cameras to many users with only one video stream from a remote camera. In another feature and advantage of embodiments of the invention, the system offers a high level of system and network security. For example, in an embodiment, a single point of entry makes the remote site more secure from network threats. In another feature and advantage of embodiments of the invention, the system offers automatic system back-up and failover. According to embodiments, multiple redundancy options for management controllers are provided. In another feature and advantage of embodiments of the invention, the system provides for zero bandwidth 24×7 recording at the edge. In another feature and advantage of embodiments of the invention, event recording is both stored at the edge and centrally located for quick operator review and redundancy.

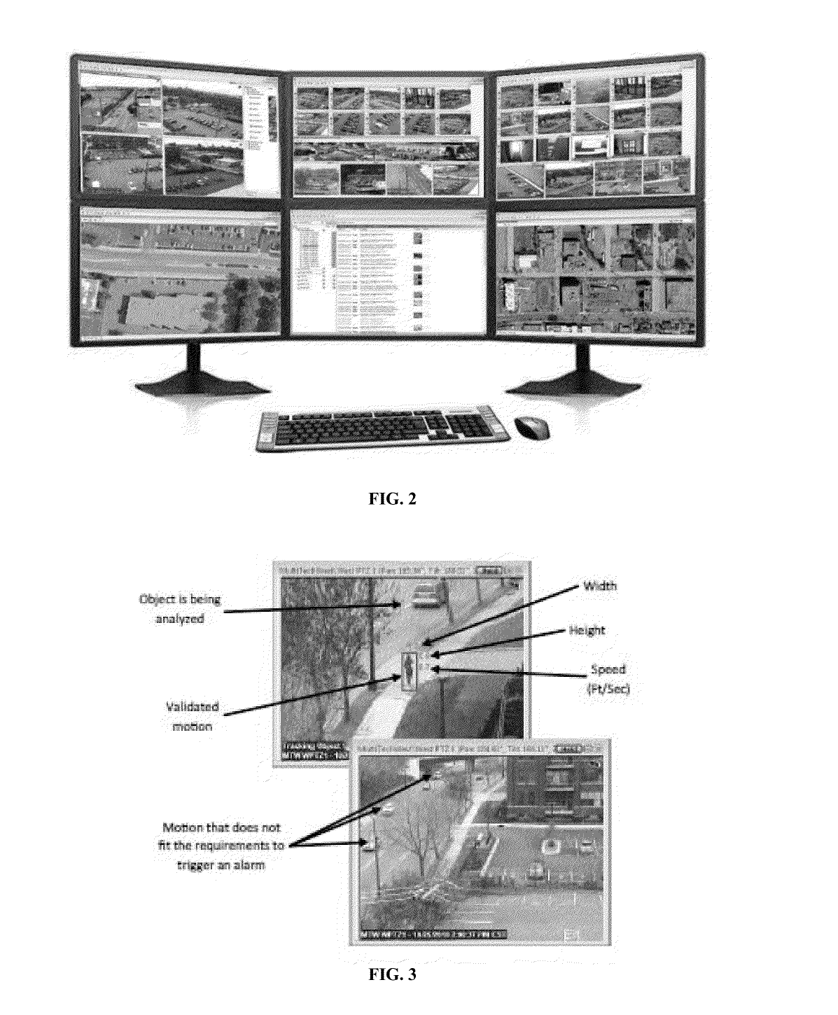

Referring to FIG. 2, an exemplary work station interface to an autonomous video management system is depicted. The user can readily interface to the system via multiple electronic displays, a keyboard, and mouse, if desired, according to embodiments.

Embodiments of the system can include an adaptive video analytics engine. Referring to FIG. 3, exemplary screenshots of output of an adaptive video analytics engine are illustrated. In a feature and advantage of embodiments of the invention, the system allows for autonomous PTZ tracking. In an embodiment, motion tracking with moving camera(s) and moving background(s) without the aid of any other cameras or triggers is done. In another feature and advantage of embodiments of the invention, only 5×5 pixels on target (POT) are needed for detection.

In another feature and advantage of embodiments of the invention, sites are laid out in geospatially 3-D coordinates. In embodiments, geospatial background logic is utilized to reject repetitive motion in the background, lighting changes, and adverse environmental conditions, for example. Other filtering or logic is also considered. According to an embodiment of the system, geospatial and camera perspectives are combined. In an embodiment, the system can identify object size, speed, location and current trajectory. Geospatial logic ensures that the same object in multiple cameras is a single object.

In another feature and advantage of embodiments of the invention, seamless camera hand-offs are conducted. In another feature and advantage of embodiments of the invention, the system detects motion and alarms only by exception. In another feature and advantage of embodiments of the invention, the system monitors motion outside defined areas but holds alarms. In another feature and advantage of embodiments of the invention, autonomous object classification classifies objects as people, automobiles, or boats and only alarms on the classified threats specified. In other embodiments, other object classifications are utilized, as appropriate. In another feature and advantage of embodiments of the invention, the system automatically and accurately determines the physical characteristics of each camera.

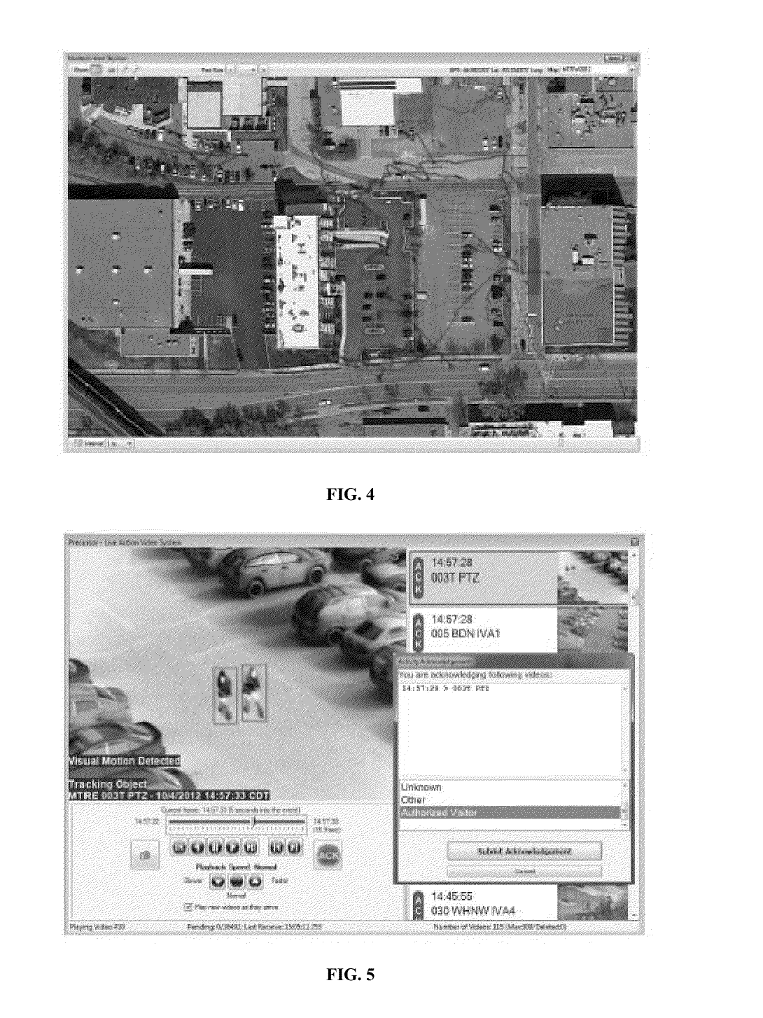

Embodiments of the system can include an interactive geospatial display module. Referring to FIG. 4, an exemplary screenshot of output of a geospatial display module is illustrated. According to an embodiment, the skyview map feature allows the creation of on-screen site perspective (e.g. floor plans, ground-plans, critical infrastructure layouts or aerial photos) with historical and real-time plotted objects from motion detection. Other views and perspectives are also considered, where appropriate within the context and scope of the application. Embodiments of the system are configured to turn site maps into interactive displays that allow users to view and analyze information from all cameras across the site. In a feature and advantage of embodiments of the invention, users can easily identify cameras, the location being viewed, the location name, and the real-time path of the object the system is tracking. In another feature and advantage of embodiments of the invention, for each PTZ camera, a user has the ability to select a spot on the map where the user would like the camera to view by simple mouse click on the map.

Embodiments of the system can include a live action video module. Referring to FIG. 5, an exemplary screenshot of output of a live action video module is illustrated. According to an embodiment, the live action video module gives users the capability to view alarm-related video images based upon either sensor (i.e. microwave) or video analytics-based alarm events. Other triggering events are also considered, such as other sensor triggers or other alarm events. In a feature and advantage of embodiments of the invention, upon a motion-detection trigger or sensor trigger, the system is configured to instantly display event information. In another feature and advantage of embodiments of the invention, a user can immediately assess pre-event and the triggered event video (post-event). In embodiments, assessment can include frame-by-frame assessment capability. In another feature and advantage of embodiments of the invention, the system provides for instant event acknowledgement with an assignment of a reason code for that event. In embodiments, the system can provide potential reason codes for the particular event, which can then be accepted by the user. In other embodiments, the user can provide the reason code. In other embodiments, the reason code is provided autonomously by the system. In another feature and advantage of embodiments of the invention, an alarm queue is used to chronologically list unacknowledged recordings and allow selection of the next recording to be displayed and/or acknowledged.

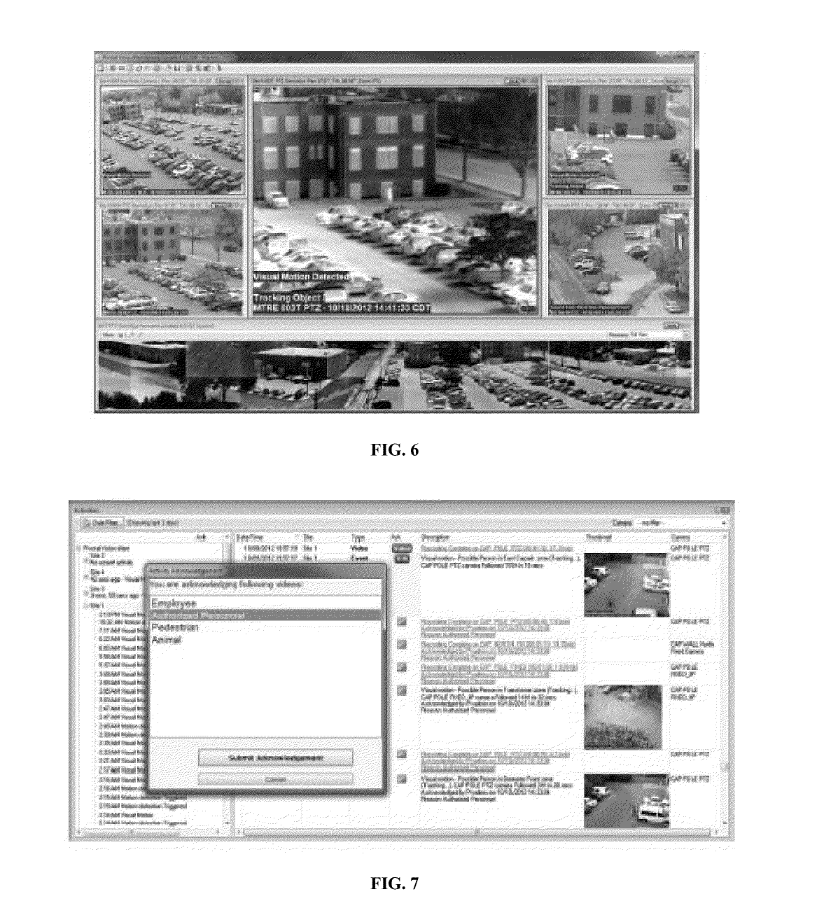

Referring to FIG. 6, an exemplary screenshot of camera displays is illustrated. Embodiments of the system can include portals windows for live video. According to an embodiment, one or more portal windows provides a display area for individual live camera views associated with the current active alarm conditions which can also be selected for viewing purposes by the user. In addition, the portal camera window can be set to populate automatically (seconds) with a camera that recently has detected motion or from a camera associated with a sensor trigger. In an embodiment, salvo tour windows provides users with a sequence of live video displays which continuously updates to show the live videos for any available camera(s) coupled to the system. Embodiments of the system can include a panorama module. In embodiments, the panorama module is configured to display what a camera can view in a 360° view (PTZ's) and field of view (FOV) of fixed view cameras. In an embodiment, the panorama is one method of providing overall PTZ navigation and provides the ability for persons that are not familiar with the site to gain a perspective as to what they are viewing.

Embodiments of the system are configured for activity logging and reporting. Referring to FIG. 7, an exemplary screenshot of an activity report window is illustrated. According to an embodiment, a report window displays a chronological listing of historical alarm events and camera recordings available for user display. In embodiments, filtering options can be by date, time and camera number, for example. Other filtering options and combinations are also available, where appropriate.

Embodiments of the system are also configured for event acknowledgement. In an embodiment, referring again to FIG. 7, utilizing an event acknowledgement module, users can acknowledge each event after the event has been reviewed and assign an administrator-defined reason code for the event. In other embodiments, reason codes are standardized according to the industry or application of the system. In embodiments, reason codes can be provided on an ad-hoc basis so as to allow flexibility in coding.

Embodiments of the system allow the user to monitor and select cameras and sensors. Referring to FIG. 8, exemplary screenshots of a system camera selector window and a sensor monitor window are illustrated. Embodiments of the system can include a system camera selector module. A system camera selector module provides the user with a list of available system cameras for selection of live video feeds to be displayed in the portals. This module also provides health monitoring of all cameras connected to the system.

In an embodiment, the system can include a sensor monitor module. In embodiments, the sensor monitor module is configured to display all of the available sensor triggers on all Input devices that are connected to the system. The user can pause sensor input triggers, temporarily halting the alarms that are associated with the corresponding triggers. This module also provides health monitoring of all sensor inputs connected (i.e. microwave, IDS systems, etc.)

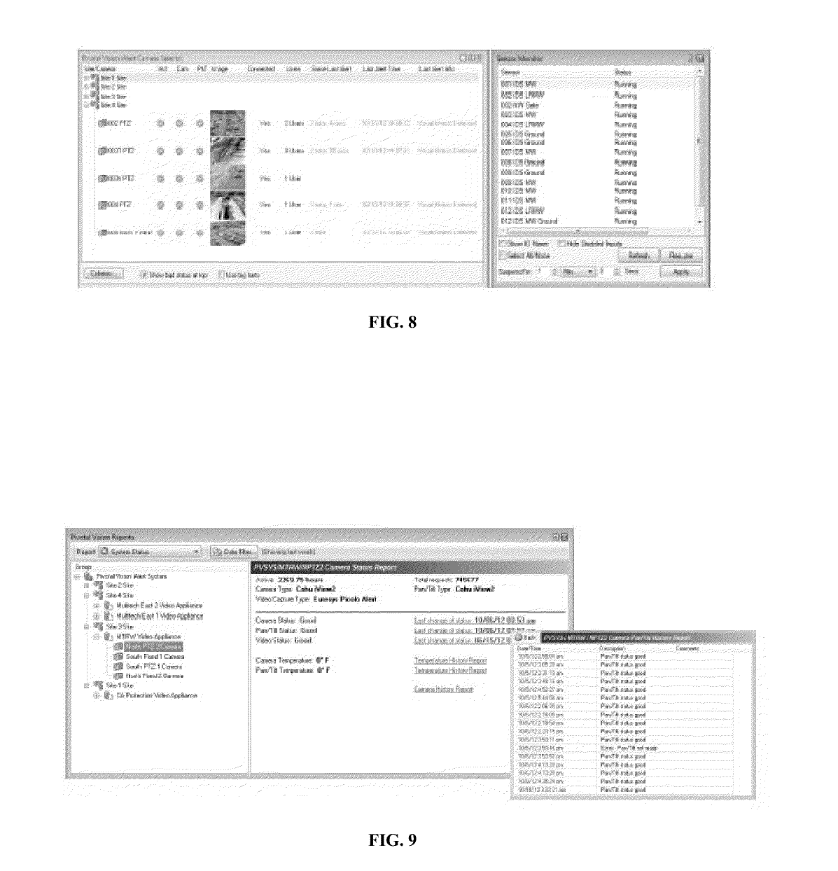

Embodiments of the system include a system status module for system monitoring. Referring to FIG. 9, exemplary screenshots of output of a system status module are illustrated. Embodiments of the system are continuously the system's own vitals. As a result, the system status module can display current and historical health status of the entire system in a hierarchical view. Other views, such as camera-specific views, location-specific views, and sensor-specific views are also possible, in embodiments.

In embodiments of the invention, alarm processing logic is provided. In a feature and advantage of embodiments of the invention, a centralized alarm management module monitors and manages all system alarms and external security alarms. In another feature and advantage of embodiments of the invention, alarm processing allows for security alarm acknowledgement. In embodiments, each alarm event can be acknowledged indicating that the event has been reviewed and the event action identified. In another feature and advantage of embodiments of the invention, alarm processing allows for the tagging of event reason codes. In embodiments, pre-defined descriptive text can be assigned for each security event by users to indicate the cause of an alarm event. In another feature and advantage of embodiments of the invention, filters are included to only show information on a specific date or within a user-defined date and time range. In another feature and advantage of embodiments of the invention, a hierarchical view of the system is available to elect and view only information relevant to a site. In embodiments, filters are included to only show information on a specific date or within a user-defined date, time range and/or by individual camera. In another feature and advantage of embodiments of the invention, the system provides user audit reporting. In an embodiment, a user audit report lists time-stamped events and statuses for each user's camera usage.

In another feature and advantage of embodiments of the invention, the system includes a sensor manager. In an embodiment, the sensor manager is configured to provide system-wide health monitoring and real-time status of all connected device status.

In another feature and advantage of embodiments of the invention, the system includes a camera manager. In an embodiment, the camera manager is configured to provide system-wide health monitoring and real-time status visibility of all connected cameras and camera communication.

In another feature and advantage of embodiments of the invention, the system includes an appliance manager. In an embodiment, the appliance manager is configured to provide system-wide health monitoring and real-time visibility of all local and remote Intelligent Video Appliances (IVAs).

In another feature and advantage of embodiments of the invention, the system includes a system health manager. In an embodiment, the system health manager is configured to provide system-wide health monitoring and real-time and historical visibility to system and network performance.

In another feature and advantage of embodiments of the invention, the system provides for e-mail and text message reporting that lists, for example, JPEG Snapshot of events and a description of the event. Other reporting options are also considered, such as automated voice message, picture message, and passive logging.

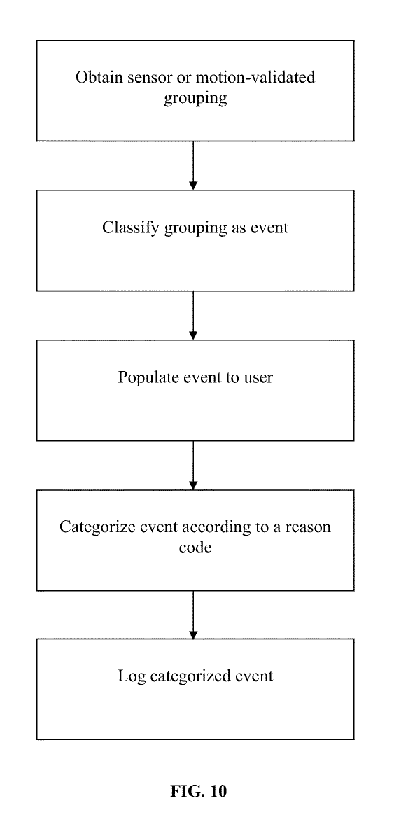

In operation, referring to FIG. 10, visual motion is first triggered. According to an embodiment, triggers can be by, for example, a triggered sensor, or a motion-validated event. Other triggers are also possible, where appropriate. For example, one camera being tripped can comprise an event. In embodiments, upon triggering, the timestamp of the video and geospatial location and GPS data are recorded.

When visual motion has been validated on a camera or an I/O input device is triggered, the system creates an event and assigns an event ID to all of the cameras associated with that event. That event ID is used to post a message to the remote console and enters it into its event queue. This notifies users that an event has occurred and that event information and recorded video is available for assessment. When the user selects an event in the event queue, 15 seconds of video from each camera associated with that selected event ID populates the first available group. All of the 15 seconds of video clips automatically start playing synchronously in the situational playback video players along with a display of live camera views. Of course, differing lengths of video clips can be populated. In embodiments, the video clip time is variable and configurable by the user. In an embodiment, thumbnail images of the first frame of the video can be populated to assist the user in understanding context of the video.

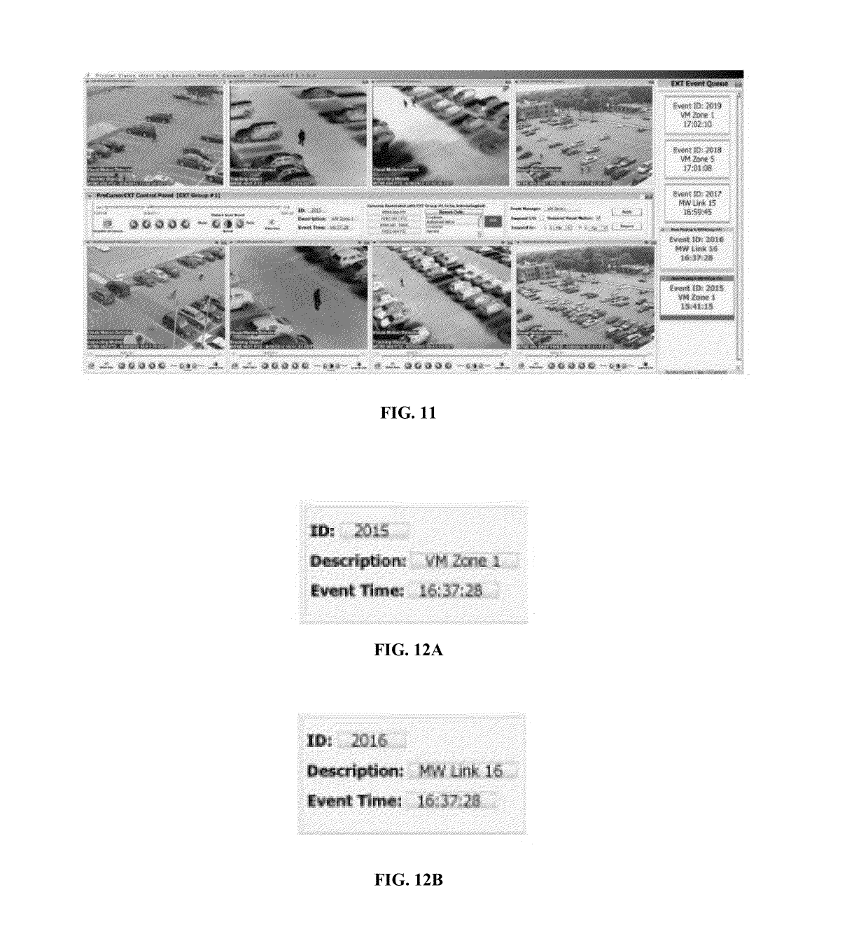

As a result, the user can immediately assess and identify what created the event, apply a reason code (or cause code) and acknowledge the event. Referring to FIG. 11, according to an embodiment, an event queue with video groupings is illustrated. Once a user acknowledges the event, all of the situational playback video players along with the live action video windows and event information clears and is ready for the next event in the event queue to be selected and assessed. In embodiments, the categorized event can be logged. In one embodiment, the activity report module logs the acknowledged event. In embodiments, an iSCSI device can be operably coupled to the system management controller for logging storage.

In embodiments, the video views are synched among the multiple cameras capturing visual motion. In this way, multiple camera views can be treated as a single event. In other embodiments, the multiple camera views are separated if desired, according to the application.

In an embodiment, an event ID is a number generated by the system to identify groups of cameras that correspond with a trigger from an I/O alarm or a visual motion analytics alarm. According to an embodiment, if an active alarm is retriggered during the initial defined post-alarm recording interval, the time of the event will be extended 10 seconds from the re-triggered event. In other embodiments, the time of the event will be extended longer or shorter than 10 seconds. In embodiments, the extension time is variable and configurable by the user. A new event will be created for that re-triggered event if the event is already in being viewed by the user.

In an embodiment, up to four cameras can be associated with a single visual motion analytics alarm event. The particular cameras associated with a visual motion analytics alarm event are defined by the geospatial processor located in the IVA, which correlates the detected motion in multiple cameras as a single object. In other embodiments, additional or fewer cameras can be associated with a single visual motion analytics alarm event. As described above, because of the architecture and digital connectivity, the under of cameras is effectively unlimited.

In an embodiment, there can be up to four cameras associated with a single I/O alarm event. In other embodiments, additional or fewer cameras can be associated with a single I/O alarm event. The particular cameras associated with a single I/O alarm event can be configured in an administrative setting in the custom automation.

In embodiments, a single visual motion analytics alarm event is created when an individual camera validates motion utilizing the analytic engine by classifying an object's size, speed, location, and current trajectory. Once the object is validated, an alarm event is generated and added to the event queue. The event can subsequently be selected in the event queue and both pre-recorded and live camera videos associated with the events are available to be assessed. Referring to FIG. 12A, an example visual motion analytics alarm event descriptor is illustrated.

In embodiments, an I/O alarm event is triggered by external input (i.e. Advantech IP data acquisition module and/or RS-232 serial communications) device connected to an IVA, for example. Once the external input is triggered, a new alarm event is generated and added to the event queue. The event can subsequently be selected in the event queue and both pre-recorded and live camera videos associated with the event are available to be assessed. Referring to FIG. 12B, an example I/O alarm event descriptor is illustrated.

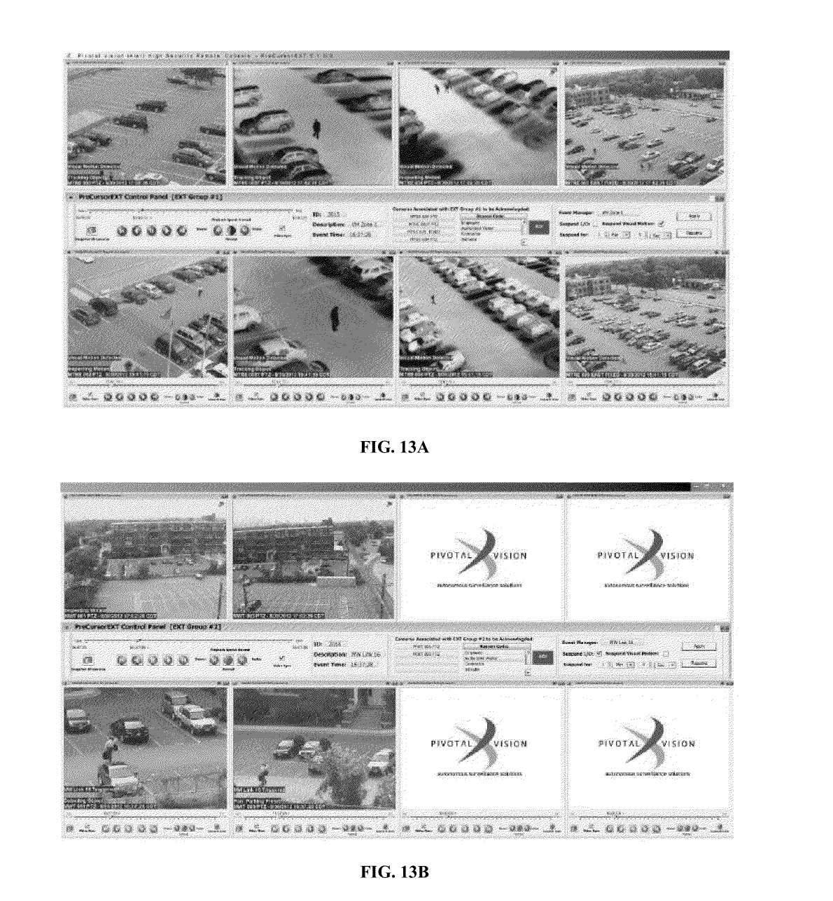

Referring to FIGS. 13A and 13B, illustrating two groups according to a distinct color and group name, a group is an identifier for a group of windows. In an embodiment, each group can have up to four situational playback video players, four corresponding live action video feeds and one control panel. In other embodiments, additional or fewer video players, live action video feeds, and control panels are considered. Each group has its own control panel for replay, printing and acknowledgment.

For illustration, “EXT Group #1” displays the first available event in the event queue and “EXT Group #2” displays the second available event in the event queue. In an embodiment, the system is configured to display up to two groups consisting of eight total windows and eight total corresponding live action video feeds. In other embodiments, additional or fewer windows and live action video feeds are possible. Each group is identified by a common toolbar with a distinct color and each group's name is identified in the title bar of each group's associated windows. For example, FIG. 13A depicts a group organized in blue and by unique name “EXT Group #1,” and FIG. 13B depicts a group organized in orange and by unique name “EXT Group #2.” In this way, more events can be displayed for assessment. For example, two users could split up the work of reviewing the groups.

According to embodiments, the system can include an event queue. In an embodiment, the event queue can have a maximum of 300 events in the queue. In other embodiments, the queue is configured for additional or fewer maximum events. The events in the event queue are identified by the event ID, the time the event occurred and the event name. Additional or fewer identifying or data points are also possible. In an embodiment, an event will populate the event queue within one second from the time the IVA has received a trigger from an external input or validation of an object from the analytic engine located on the IVA. In other embodiments, different refresh or population times are possible.

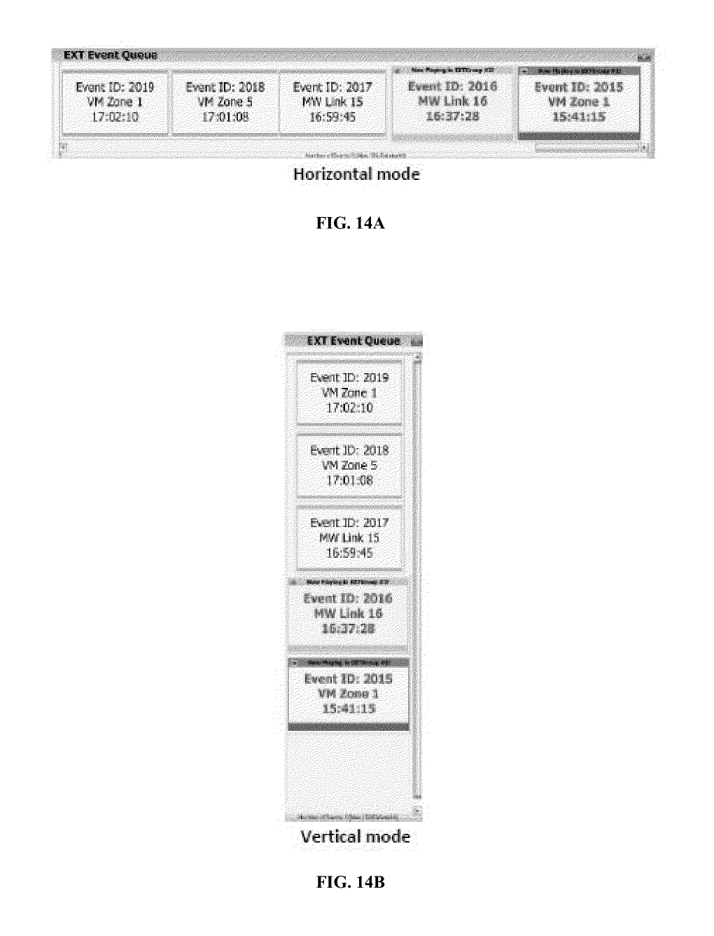

Referring to FIGS. 14A and 14B, the user has the option to have the event queue laid out to display the events horizontally or vertical. In an embodiment, the event queue is sorted chronologically by time with the options of the user to display the most recent events at the top of the list or bottom of the list when in the vertical setting (FIG. 14B) or display the most recent events from left to right or display the most recent events to the right to left when in the horizontal setting (FIG. 14A).

In an embodiment, the event queue window location is not fixed to any particular display device and may be rearranged as necessary to best suit the needs of any user. In other embodiments, the event queue window can be fixed to a particular display or display location. The event-based queue identifies events by visual motion analytics alarm events and I/O alarm events. In embodiments, the events are displayed chronologically and sorted by the time the event occurred. The active visual motion analytics alarm events and I/O alarm events can be identified as separate event alarm types in the event based queue along with an indication of the alarm event time associated with each individual alarm event.

In embodiments, the user has the option to have the next available group automatically populate when an event is triggered. Alternatively, the user can choose to have the event populate the group once the user selects an event in the event queue so it does not interrupt any of the user's action while reviewing or acknowledging previous events as new events populate the event queue. Thus, in embodiments, there is no interruption of the user's action while reviewing or acknowledging previous events as new events populate the event queue. Further, in embodiments, any active alarms listed in the event queue are selectable by the user for display and assessment purposes.

According to embodiments, the system can include a situational playback video player. A situational playback video player is one of four windows in a group that plays back the recorded camera video of an event. In an embodiment, the default setting is 5 seconds before the triggered event and 10 seconds post event. Of course, other timing settings for playback are also possible and can be variable and user-defined. In an embodiment, all of the alarm-related situational playback video player windows can populate within a half a second from the time the user selects the event in the event queue. In other embodiments, other population times are considered. According to an embodiment, the video player windows are configured for 15 fps pre-event (default 5 fps, in an embodiment) and 30 fps post-event (default 10 fps, in an embodiment). Other frames rates are also possible for both pre-event and post-event. In embodiments, the situational playback video player is capable of playback of a speed that is 3× faster than the normal speed or 3× slower. Other playback speeds are also possible.

In an embodiment, once an event has been acknowledged, all of the situational playback video player windows clear along with the associated live action video feeds. The situational playback video player window locations are not fixed to any particular display device and may be rearranged as necessary to best suit the needs of each user. In other embodiments, the situational playback video player windows can be fixed to a particular display or display location. In embodiments, alarm-related situational playback video player windows are displayed for each camera associated with the initiating alarm event. All of the cameras associated with the event can be displayed simultaneously in a group. Further, the situational playback video player controls give the user the ability to manipulate the playback of the video currently playing and take a snapshot of videos or alternatively send it directly to a printer.

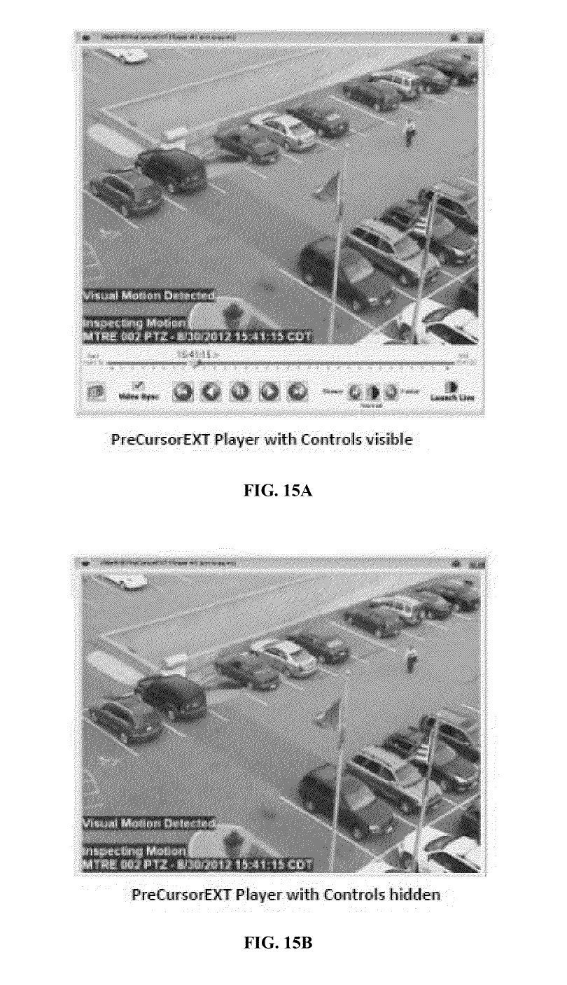

Referring to FIGS. 15A and 15B, the situational playback video player can be configured such that the user can hide the individual player controls. For example, FIG. 15A is a screenshot of an situational playback video player having controls visible, according to an embodiment of the invention, and FIG. 15B is a screenshot of an situational playback video player having controls hidden, according to an embodiment of the invention.

According to embodiments, once an event is selected to play in an group, the timeline displays the start time of the video, the time the event started, and the time the event ends. When a situational playback video player is selected to un-synchronize, an indicator shows how far into the event the user has viewed. If the user wants to view the live camera feed, they can select the “Launch Live” control to open the live action video feed window associated with that situational playback video player.

Myriad playback options are possible with embodiments of the situational playback video player. The player can play forward, play backwards, play forward by frame, play backward by frame, and configure play speed faster or slower, for example, ranging up to 3× faster and 3× slower, in embodiments. The player video sync also gives the user the ability to sync or un-sync the all of the situational playback video players so the user can use individual video player controls.

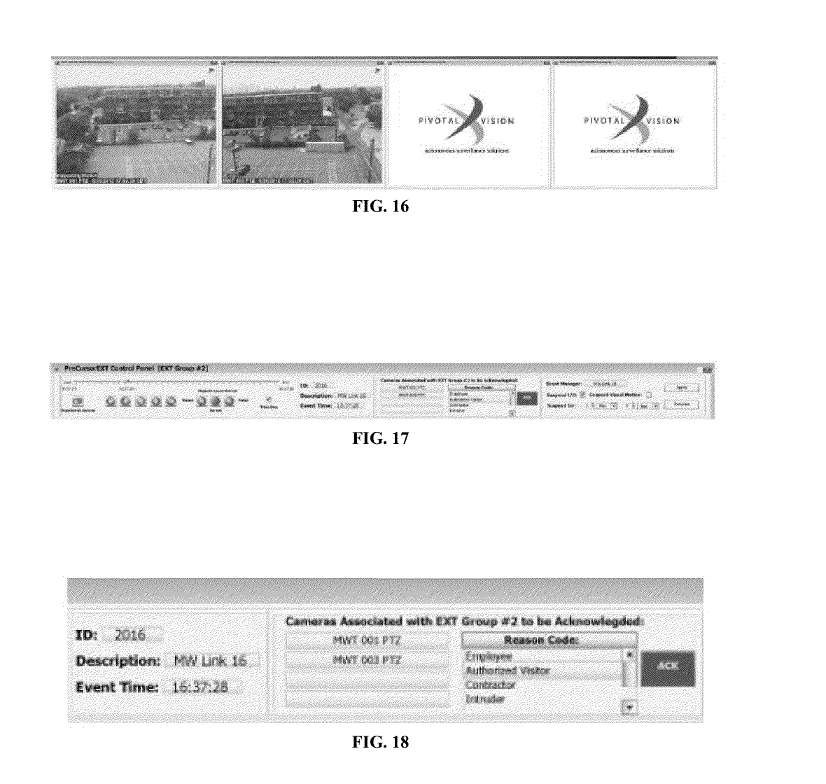

In an embodiment, the system can include live action video windows. The live action video feed is one of four windows in a group that displays the live camera video feed of a corresponding initiating event window. For example, FIG. 16 is a screenshot of a live action video feed, according to an embodiment of the invention.

In embodiments, all of the alarm-related live action video feed windows can populate within a half a second from the time the user selects the event in the event queue. Other population timings are possible in other embodiments. The live action video feed windows can be configured for 30 fps. In embodiments, this setting is adjustable by an administrator and can be set at other frame rates. In embodiments, for example, a user can launch up to four associated live action video feed windows (minimum one associated live action video feed windows) per group. Additional or fewer associated live action video feed windows per group can also be launched.

Alarm-related live videos are displayed for each window associated with the initiating alarm event, in embodiments. The live action video window locations can be configured so as to not be fixed to any particular display device and may be rearranged as necessary to best suit the needs of the user. In other embodiments, the live action video windows can be fixed to a particular display or display location. Live action video windows can be associated with events and can be laid out to display next to the associated situational playback video player window. Once an event has been acknowledged, all of the associated live action video windows (live camera) can be configured to clear, along with the associated situational playback video player window.

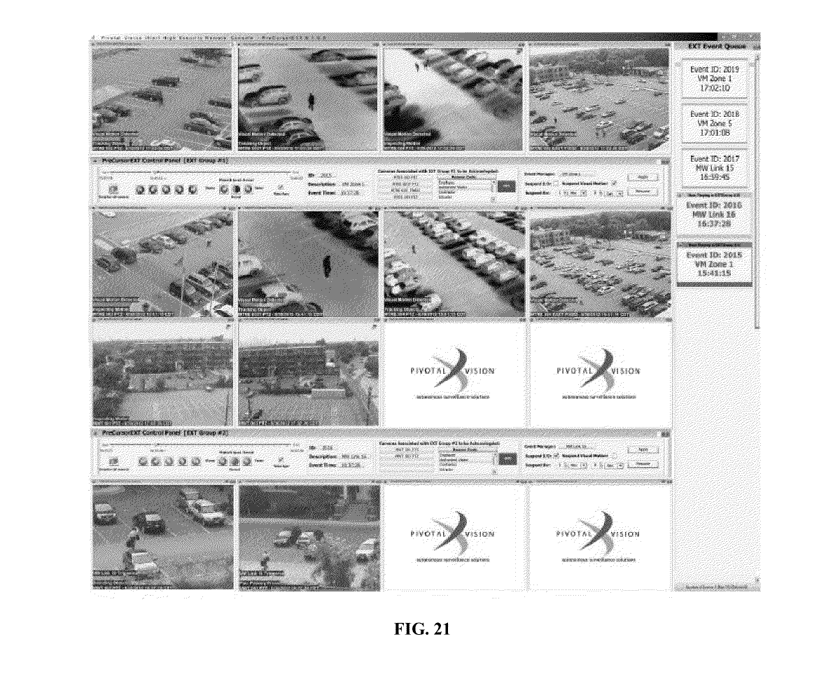

In an embodiment, the system can include a control panel. For example, referring to FIGS. 17 and 21, the control panel can be the main controls for each group's synchronized situational playback video player window(s). Via the control panel, users can control the playback speed, pause all of the active video players and take a snapshot of all of the cameras associated to its group at the same time. In embodiments, the control panel window locations are not fixed to any particular display device and may be rearranged as necessary to best suit the needs of any user. In other embodiments, the control panel windows can be fixed to a particular display or display location.

Referring to FIG. 18 and group acknowledgments, in operation, all of the cameras associated with each event are displayed along with all of the details of the event including the event ID, description, event time, and the current system time. The user can acknowledge the event by first assigning a reason code to the event and selecting the “Ack” button. In embodiments, the “Ack” button can be colored or highlighted for ease of use. Upon acknowledgement of the initiating alarm event, the system clears the playback windows (pre-recorded videos) and live action video windows (live camera feeds) directly associated with that acknowledged alarm event. In embodiments, upon acknowledgement of the initiating alarm event, all of the live cameras windows set as portal and associated with the initiating alarm event ID will automatically clear system-wide for all users logged in to the remote console. In other embodiments, the live camera feeds and pre-recorded videos can be selectively cleared based on user, permissions, location of operation, or other appropriate criteria. Upon acknowledgement of the initiating alarm event, the event information along with recorded videos associated with the initiating alarm event ID can be automatically sorted and posted in the remote console activity eeports for further review of the event.

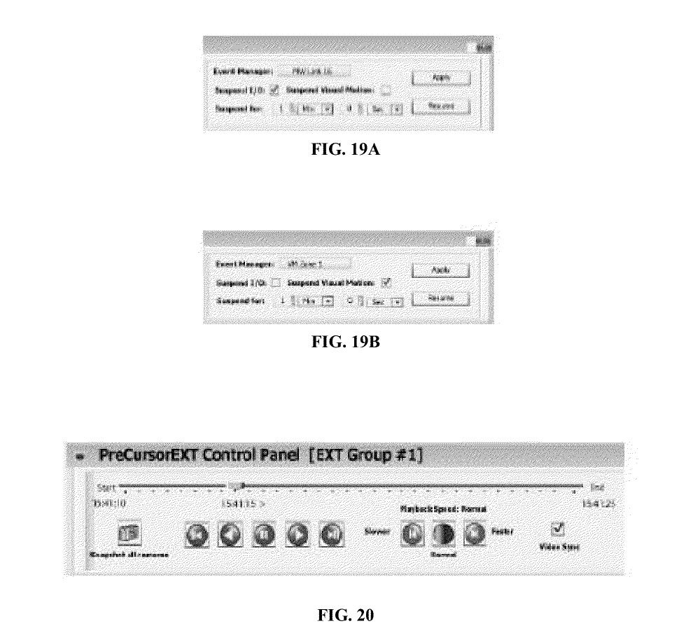

In an embodiment, the system can include an event manager. The event manager allows each user the ability to identify which camera or input triggered the event and temporally suspend that input or group of cameras that trigger from visual motion. For example, referring to FIG. 19A, the current I/O can be suspended for a user-defined time frame. FIG. 19A illustrates an example with a checkbox for suspending I/O. In another example, referring to FIG. 19B, the motion alarm can be suspended for a group of cameras for a user-defined time. FIG. 19B illustrates an example with a checkbox for suspending visual motion.

Referring to FIG. 20, the group playback controls allows the user the ability to manipulate the playback of all of the cameras in the group and can be configured to take a snapshot of all of the videos in the group. The group video(s) timeline allows the user perspective on the events. For example, once an event is selected to play in an group, the timeline displays the beginning time of the event, the time the event started and the time the event ends. When all situational playback video player windows are selected to synchronized, an indicator shows how far into the event the user as viewed. Myriad playback options are available, in embodiments. The group playback controls can play forward, play backwards, play forward by frame, play backward by frame, and configure play speed faster or slower, for example, ranging up to 3× faster and 3× slower, in embodiments. In embodiments, a video sync feature allows the user the ability to sync or un-sync the video windows so the user can use each window individual control separately or in combination with other videos.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be formed or combined. Accordingly, the embodiments are not mutually exclusive combinations of features; rather, the invention may comprise a combination of different individual features selected from different individual embodiments, as understood by persons of ordinary skill in the art.

The entire content of each and all patents, patent applications, articles and additional references, mentioned herein, are respectively incorporated herein by reference.

The art described is not intended to constitute an admission that any patent, publication or other information referred to herein is “prior art” with respect to this invention, unless specifically designated as such. In addition, any description of the art should not be construed to mean that a search has been made or that no other pertinent information as defined in 37 C.F.R. §1.56(a) exists.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. An autonomous video management system comprising:
one or more remote sites, each of the one or more remote sites including an intelligent video appliance operably coupled to one or more cameras;
a system management controller configured to:
provide an operable connection to one or more user interface workstations for monitoring events at the one or more remote sites,
trigger an event by evaluating activity detected by the one or more cameras,
associate at least two of the one or more cameras with the event,
associate an event ID with the at least two of the one or more cameras associated with the event, and
present the event on the one or more user interface workstations; and
a network operably coupling the intelligent video applicance and the system management controller.

2. The system of claim 1, wherein the system management controller is further configured to identify a location associated with each event and present the event and the location on the one or more user interface workstations.

3. The system of claim 1, wherein the intelligent video appliance is further operably coupled to one or more sensors, wherein the events are triggered by activity detected by the one or more sensors.

4. The system of claim 3, wherein the system management controller is further configured to associate the one or more sensors with the event.

5. The system of claim 1, wherein each of the one or more user interface workstations is configured to display a skyline map view of a geoterrestrial location.

6. The system of claim 1, wherein the location associated with each event is identified by at least one of an event ID, an zone site, an input device, or an event time.

7. The system of claim 1, wherein presenting the event comprises displaying, at the one or more user interface workstations, a first portion of video prior to the event and a second portion of video after the event.

8. The system of claim 1, wherein the system management controller is further configured to display, at the one or more user interface workstations, an event queue of all non-acknowledged events.
